(19) United States
(12) Patent Application Publication
(10) Pub. No.: US 2023/0230204 A1
(43) Pub. Date: Jul. 20, 2023

(54) IMAGE PROCESSING METHOD AND APPARATUS, AND METHOD AND APPARATUS FOR TRAINING IMAGE PROCESSING MODEL

(71) Applicant: MEGVII (BEIJING) TECHNOLOGY CO., LTD., Beijing (CN)

(72) Inventors: Luhui XU, Beijing (CN); Haoqiang FAN, Beijing (CN); Shuai LI, Beijing (CN)

(21) Appl. No.: 17/775,493

(22) PCT Filed: Sep. 30, 2020
(86) PCT No.: PCT/CN2020/119540

§ 371 Date: May 9, 2022

(30) Foreign Application Priority Data
Jan. 20, 2020 (CN) 202010068627.6
Mar. 13, 2020 (CN) 202010179545.9

(51) Int. Cl. G06T 5/00; H04N 23/53; G06T 5/50

(52) U.S. Cl. CPC G06T 5/001; H04N 23/53; G06T 5/50; G06T 2207/20081

(57) ABSTRACT

An image processing method and apparatus, and a method and apparatus for training an image processing model, which relates to the technical field of image processing. The image processing method includes: acquiring an original diffraction image; inputting the original diffraction image into an image processing model (S304); and by using the image processing model, performing restoration processing to the original diffraction image, to obtain a target standard image corresponding to the original diffraction image.

The present application claims the priority of the Chinese patent application filed on Jan. 20, 2020 before the Chinese Patent Office with the application number of 202010068627.6 and the title of “IMAGE PROCESSING METHOD AND APPARATUS, AND METHOD AND APPARATUS FOR TRAINING IMAGE PROCESSING MODEL”, and the priority of the Chinese patent application filed on Mar. 13, 2020 before the Chinese Patent Office with the application number of 202010179545.9 and the title of “IMAGE PROCESSING METHOD AND APPARATUS, AND METHOD AND APPARATUS FOR TRAINING IMAGE PROCESSING MODEL”, which are incorporated herein in their entirety by reference.

### TECHNICAL FIELD

The present disclosure relates to the technical field of image processing, and particularly relates to an image processing method and apparatus, and a method and an apparatus for training an image processing model.

### BACKGROUND

With the development of the technology of mobile terminal and the demands of users, full-screen terminals have become an important development trend. In the related art, terminal devices are provided with a front-facing camera, and usually a slot or hole is provided at the position of the display screen of the terminal devices where the front-facing camera is installed, whereby the front-facing camera can collect an external image. However, the slot or hole formed in the display screen of the terminal devices reduces the screen-to-body ratio of the display screen.

In the mobile terminals using a full screen for displaying, an under-screen camera has gradually become a preferable solution for implementing the full screen. The under-screen camera refers to that, when the display screen is not provided with a hole, the front-facing camera is hidden under the display screen, and, in usage, the camera can perform framing and photographing via a light transmitting region of the display screen.

However, the inventor has found by studying that, in conventional solutions of the under-screen camera, the display screen has a poor effect of displaying.

### SUMMARY

In view of the above, an object of the present disclosure is to provide an image processing method and apparatus, and a method and an apparatus for training an image processing model, which can effectively improve the quality of the image that is restored, and increase the clarity of the image.

In order to achieve the above objects, the technical solutions according to the embodiments of the present disclosure are as follows:

In the first aspect, an embodiment of the present disclosure provides an image processing method, wherein the method is applied to an electronic device, and the method comprises:

acquiring an original diffraction image;

inputting the original diffraction image into an image processing model; and

by using the image processing model, performing restoration processing to the original diffraction image, to obtain a target standard image corresponding to the original diffraction image.

Optionally, the step of, by using the image processing model, performing the restoration processing to the original diffraction image, to obtain the target standard image corresponding to the original diffraction image comprises:

by using the image processing model, detecting luminance values of pixel points in the original diffraction image;

based on the detected luminance values, determining a light-spot region that contains a target light source in the original diffraction image; and

based on the light-spot region, performing the restoration processing to the original diffraction image, to obtain the target standard image corresponding to the original diffraction image.

Optionally, the step of, based on the light-spot region, performing the restoration processing to the original diffraction image comprises:

removing diffraction fringes from the light-spot region, to obtain an image to be restored corresponding to the original diffraction image; and

performing clarity processing to the image to be restored, to obtain the target standard image.

Optionally, the step of, based on the detected luminance values, determining the light-spot region that contains the target light source in the original diffraction image comprises:

according to positions of pixel points whose detected luminance values are greater than a preset luminance threshold, determining a luminance region in the original diffraction image;

determining whether a radius of a circumcircle of the luminance region is greater than a preset radius; and

if yes, determining the luminance region to be the light-spot region that contains the target light source.

Optionally, the step of acquiring the original diffraction image comprises:

by using an under-screen camera provided at the electronic device, collecting the original diffraction image.

Optionally, the image processing model is obtained by training based on an image-sample pair, wherein the image-sample pair comprises a sample standard image of a specified scene photographed by using an on-screen camera and a sample diffraction image corresponding to the sample standard image, wherein the sample diffraction image is an image obtained by simulating the under-screen camera to photograph the specified scene based on the sample standard image, and/or is an image obtained by photographing the specified scene by using the under-screen camera.

Optionally, the electronic device comprises a display screen, and the display screen comprises a plurality of light emitting units and a plurality of light transmitting regions, wherein each of the light emitting units comprises sub-pixels of a preset quantity; and the plurality of sub-pixels of the plurality of light emitting units have gaps therebetween, to form the plurality of light transmitting regions in the gaps, wherein the plurality of light transmitting regions include at least two non-repetitive first light transmitting regions.

Optionally, each of the sub-pixels in the plurality of light emitting units is separate from each of the plurality of light transmitting regions.

Optionally, the light transmitting regions are arranged in one or more of the following modes:

the at least two first light transmitting regions have different size parameters, appearance parameters, gesture parameters and position-distribution parameters;

each of the first light transmitting regions and another light transmitting region have different size parameters, appearance parameters, gesture parameters and position-distribution parameters; and

all of the light transmitting regions have different size parameters, appearance parameters, gesture parameters and position-distribution parameters.

Optionally, the electronic device comprises a display screen, and the display screen comprises a plurality of light emitting units and a plurality of light transmitting regions, wherein each of the light emitting units comprises sub-pixels of a preset quantity; and the plurality of sub-pixels of at least two of the light emitting units are non-repetitively distributed.

Optionally, at least two light transmitting regions that are non-repetitively distributed are formed in gaps between the plurality of sub-pixels that are non-repetitively distributed.

Optionally, the light emitting units are arranged in one or more of the following modes:

the plurality of sub-pixels of at least two of the light emitting units have different size parameters, appearance parameters, gesture parameters and position-distribution parameters;

the plurality of sub-pixels of at least two of the light emitting units and a plurality of sub-pixels of another light emitting unit have different size parameters, appearance parameters, gesture parameters and position-distribution parameters; and

a plurality of sub-pixels of all of the light emitting units have different size parameters, appearance parameters, gesture parameters and position-distribution parameters.

Optionally, the electronic device is an electronic device having an under-screen camera.

In the second aspect, an embodiment of the present disclosure further provides a method for training an image processing model, wherein the method comprises:

inputting an image-sample pair into the image processing model, wherein the image-sample pair comprises a sample standard image and a sample diffraction image corresponding to the sample standard image;

by using the image processing model, performing restoration processing to the sample diffraction image, to obtain a restored image of the sample diffraction image;

according to the restored image and the sample standard image, determining a loss-function value corresponding to the image processing model; and

according to the loss-function value, performing iterative updating to parameters of the image processing model.

Optionally, the step of, according to the loss-function value, performing the iterative updating to the parameters of the image processing model comprises:

determining whether the loss-function value is converged to a preset value, and/or whether the iterative updating reaches a preset time quantity; and

on the condition that the loss-function value is converged to the preset value and/or the iterative updating reaches the preset time quantity, obtaining a trained image processing model.

Optionally, the step of, according to the restored image and the sample standard image, determining the loss-function value corresponding to the image processing model comprises:

calculating a similarity between the restored image and the sample standard image, and according to the similarity, determining the loss-function value corresponding to the image processing model.

Optionally, the image-sample pair is acquired by:

by using an on-screen camera, photographing a specified scene, to obtain the sample standard image;

by using the on-screen camera, via a displaying screen, photographing a target light source in a dark background, to obtain a target-light-source image; and

performing convolution operation to the target-light-source image and the sample standard image, to obtain the sample diffraction image.

Optionally, the step of, by using the on-screen camera, via the displaying screen, photographing the target light source in the dark background, to obtain the target-light-source image comprises:

by using the on-screen camera, via the displaying screen, photographing the target light source in a predetermined theme, to obtain a candidate target-light-source image, wherein the predetermined theme refers to a theme for performing spatial arrangement to at least one target light source in a dark background, in different instances of the predetermined theme a quantity of the target light sources and/or a mode of the spatial arrangement of the target light sources are different, and candidate target-light-source images corresponding to different instances of the predetermined theme are different; and

determining at least one of the candidate target-light-source images to be the target-light-source image.

Optionally, before the step of performing the convolution operation to the target-light-source image and the sample standard image, the method further comprises:

performing denoising processing to the target-light-source image.

Optionally, the displaying screen is the same as the display screen of the electronic device in the image processing method stated above.

Optionally, the image-sample pair is acquired by:

by using an on-screen camera, at a preset photographing angle, photographing a specified scene, to obtain a sample standard image; and

by using an under-screen camera, at the photographing angle, photographing the specified scene, to obtain the sample diffraction image.

In the third aspect, an embodiment of the present disclosure provides an image processing apparatus, wherein the apparatus is applied to an electronic device, and the apparatus comprises:

an image collecting module configured for acquiring an original diffraction image;

an image inputting module configured for inputting the original diffraction image into an image processing model; and

an image restoring module configured for, by using the image processing model, performing restoration processing to the original diffraction image, to obtain a target standard image corresponding to the original diffraction image.

In the fourth aspect, an embodiment of the present disclosure provides an apparatus for training an image processing model, wherein the apparatus comprises:

an inputting module configured for inputting an image-sample pair into the image processing model, wherein the image-sample pair comprises a sample standard image and a sample diffraction image corresponding to the sample standard image;

a restoring module configured for, by using the image processing model, performing restoration processing to the sample diffraction image, to obtain a restored image of the sample diffraction image;

a calculating module configured for, according to the restored image and the sample standard image, determining a loss-function value corresponding to the image processing model; and

an updating module configured for, according to the loss-function value, performing iterative updating to parameters of the image processing model.

In the fifth aspect, an embodiment of the present disclosure provides an image processing system, wherein the system comprises a processor and a storage device; and

the storage device stores a computer program, and the computer program, when executed by the processor, implements the image processing method according to any one of the items in the first aspect, or implements the method for training an image processing model according to any one of the items in the second aspect.

In the sixth aspect, an embodiment of the present disclosure provides an electronic device, wherein the electronic device comprises a display screen and an under-screen camera, and further comprises the image processing system according to the fifth aspect; and

the display screen comprises a plurality of light emitting units and a plurality of light transmitting regions, wherein each of the light emitting units comprises a plurality of sub-pixels.

Optionally, the plurality of sub-pixels of the plurality of light emitting units have gaps therebetween, to form the plurality of light transmitting regions in the gaps, wherein the plurality of light transmitting regions include at least two non-repetitive first light transmitting regions.

Optionally, the plurality of sub-pixels of at least two of the light emitting units are non-repetitively distributed.

In the seven aspect, an embodiment of the present disclosure provides a computer-readable storage medium, the computer-readable storage medium storing a computer program, wherein the computer program, when executed by a processor, implements the steps of the image processing method according to any one of the items in the first aspect, or implements the steps of the method for training an image processing model according to any one of the items in the second aspect.

The embodiment of the present disclosure provides an electronic device, wherein the electronic device comprises a display screen and an under-screen camera. The display screen comprises a plurality of light emitting units and a plurality of light transmitting regions; and each of the light emitting units comprises sub-pixels of a preset quantity. The plurality of light transmitting regions are non-repetitively arranged between the sub-pixels of the plurality of light emitting units, whereby the diffraction-fringe image that is generated by the target light source via the display screen is an image of evenly distributed fringes. The regularity of the image of evenly distributed fringes can be accurately determined, whereby in the image processing the difficulty of the image restoration can be reduced.

An embodiment of the present application further provides a computer program, wherein the computer program comprises a computer-readable code, and when the computer-readable code is executed in a computing and processing device, the computer-readable code causes the computing and processing device to implement the image processing method stated above or the method for training an image processing model stated above.

The above description is merely a summary of the technical solutions of the present disclosure. In order to more clearly know the elements of the present disclosure to enable the implementation according to the contents of the description, and in order to make the above and other purposes, features and advantages of the present disclosure more apparent and understandable, the particular embodiments of the present disclosure are provided below.

The embodiments of the present disclosure provide an image processing method and apparatus. In the image processing method, the acquired original diffraction image is inputted into the image processing model, and the original diffraction image is restored by using the image processing model, to obtain the target standard image corresponding to the original diffraction image. The above-described image processing mode according to the present embodiment can restore the original diffraction image by directly using the image processing model, which effectively simplifies the mode of the image restoration and can increase the clarity of the target standard image that has been restored, thereby effectively improving the effect of the displaying of the image by the display screen.

The embodiments of the present disclosure provide a method and an apparatus for training an image processing model. The training method comprises inputting the image-sample pair into the image processing model, by using the image processing model, performing restoration processing to the sample diffraction image, to obtain a restored image of the sample diffraction image; according to the restored image and the sample standard image, determining a loss-function value corresponding to the image processing model; and performing iterative updating to parameters of the image processing model. In the above-described training mode according to the present embodiment, by using the sample standard image and the sample diffraction image having the correspondence relation as the training data, the difference between the two images in the image-sample pair can be reduced, or, in other words, the quality of the image-sample pair is increased. The image-sample pair of the higher quality facilitates to improve the effect of the training of the image processing model, and can increase the efficiency and the accuracy rate of the training of the image processing model.

The other characteristics and advantages of the present disclosure will be described in the subsequent description. Alternatively, some of the characteristics and advantages can be inferred or unambiguously determined from the description, or can be known by implementing the above-described technical solutions of the present disclosure.

In order to make the above purposes, features and advantages of the present disclosure more apparent and understandable, the present disclosure will be described in detail below with reference to the preferable embodiments and the drawings.

### BRIEF DESCRIPTION OF THE DRAWINGS

In order to more clearly illustrate the technical solutions of the particular embodiments of the present disclosure or the prior art, the figures that are required to describe the particular embodiments or the prior art will be briefly introduced below. Apparently, the figures that are described below are embodiments of the present disclosure, and a person skilled in the art can obtain other figures according to these figures without paying creative work.

FIG. 1 shows a schematic structural diagram of the electronic device according to an embodiment of the present disclosure;

FIG. 2 shows a schematic structural diagram of the display screen according to an embodiment of the present disclosure;

FIG. 3 shows a flow chart of the image processing method according to an embodiment of the present disclosure;

FIG. 4 shows an schematic diagram of the original diffraction image according to an embodiment of the present disclosure;

FIG. 5 shows an schematic diagram of the target standard image according to an embodiment of the present disclosure;

FIG. 6 shows a flow chart of the method for training an image processing model according to an embodiment of the present disclosure;

FIG. 7 shows a schematic diagram of the scene of the photographing of the target-light-source image according to an embodiment of the present disclosure;

FIG. 8 shows a structural block diagram of the image processing apparatus according to an embodiment of the present disclosure;

FIG. 9 shows a structural block diagram of the apparatus for training an image processing model according to an embodiment of the present disclosure; and

FIG. 10 shows a structural block diagram of the electronic device according to an embodiment of the present disclosure.

### DETAILED DESCRIPTION

In order to make the objects, the technical solutions and the advantages of the embodiments of the present disclosure clearer, the technical solutions of the present disclosure will be clearly and completely described below with reference to the drawings. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

Generally, the sub-pixels in the light emitting units of a display screen are arranged repeatedly. For example, the arrangements of the sub-pixels of each of the light emitting units in a plurality of light emitting units are completely the same. Alternatively, a plurality of light emitting units are used as one pixel module, and the arrangements of the sub-pixels in each of the pixel modules formed by a plurality of light emitting units are completely the same. However, regarding the under-screen camera, when an external target light source is transmitting the screen, diffraction fringes of the shape of “raindrops” are formed in the image collected by using the under-screen camera. The diffraction fringes unevenly attenuate from the center to the edges, which results in that the image photographed by using the camera correspondingly has obscureness with a nonuniform distribution. In an image restoration process, because the uneven diffraction fringes are difficult to remove, the restored image has a poor clarity, which seriously affects the quality of the restored image.

In solutions of the under-screen camera, the inventor has found by studying that the structures of conventional display screens result in the uneven diffraction fringes, and because the regularity of the diffraction fringes cannot be accurately determined, the diffraction fringes in the image cannot be accurately identified and removed, whereby the image containing the target light source is difficult to restore, and the image that has been restored has a poor clarity, which seriously affects the quality of the restored image. In view of that, in order to ameliorate at least one of the above problems, the embodiments of the present disclosure provide an image processing method and apparatus, and a method and an apparatus for training an image processing model, which can effectively improve the quality of the image that has been restored, and increase the clarity of the image. That technique may be applied to various under-screen shooting products, such as a mobile phone, a computer, a camera and a biomedical imaging device. In order to facilitate the comprehension, the embodiments of the present disclosure will be described in detail below.

### The First Embodiment

Firstly, an exemplary electronic device 100 for implementing the image processing method and apparatus, and the method and the apparatus for training an image processing model according to the embodiments of the present disclosure is described with reference to FIG. 1.

FIG. 1 shows a schematic structural diagram of an electronic device. The electronic device 100 includes one or more processors 102, one or more storage devices 104, an inputting device 106, an outputting device 108 and an image collecting device 110, and those components are interconnected by a bus system 112 and/or a connecting mechanism in another form (not shown). It should be noted that the components and the structure of the electronic device 100 shown in FIG. 1 are merely exemplary, rather than limiting, and, according to the demands, the electronic device may have some of the components shown in FIG. 1, and may also have components and structures not shown in FIG. 1.

The processors 102 may be a central processing unit (CPU) or a processing unit in another form having a data handling capacity and/or an instruction executing capacity, and may control the other components in the electronic device 100 to perform the desired functions.

The storage device 104 may include one or more computer program products. The computer program products may include various types of computer-readable storage mediums, such as a volatile memory and/or a nonvolatile memory. The volatile memory may include, for example, a random access memory (RAM) and/or a cache and so on. The nonvolatile memory may include, for example, a read-only memory (ROM), a hard disk, a flash memory and so on. The computer-readable storage mediums may store one or more computer program instructions, and the processor 102 may execute the program instructions, to realize the client functions in the embodiments of the present disclosure described below (realized by the processor) and/or other desired functions. The computer-readable storage mediums may further store various application programs and various data, for example, the various data used and/or generated by the application programs.

The inputting device 106 may be a device used by the user to input an instruction, and may include one or more of a keyboard, a mouse, a microphone, a touch screen and so on.

The outputting device 108 may output various information (for example, images or sounds) to the exterior (for example, the user), and may include one or more of a display, a loudspeaker and so on.

The image collecting device 110 may photograph an image desired by the user (such as a photograph, a video and so on), and store the photographed image in the storage device 104 for usage by the other components.

As an example, the exemplary electronic device for implementing the image processing method and apparatus, and the method and apparatus for training an image processing model according to the embodiments of the present disclosure may be implemented in an intelligent terminal such as a smartphone, a tablet personal computer and a computer.

### The Second Embodiment

The present embodiment provides an image processing method, and the method may be applied to an electronic device. In order to better understand the technical solutions of the present disclosure, the electronic device is firstly described on the basis of the above-described embodiment.

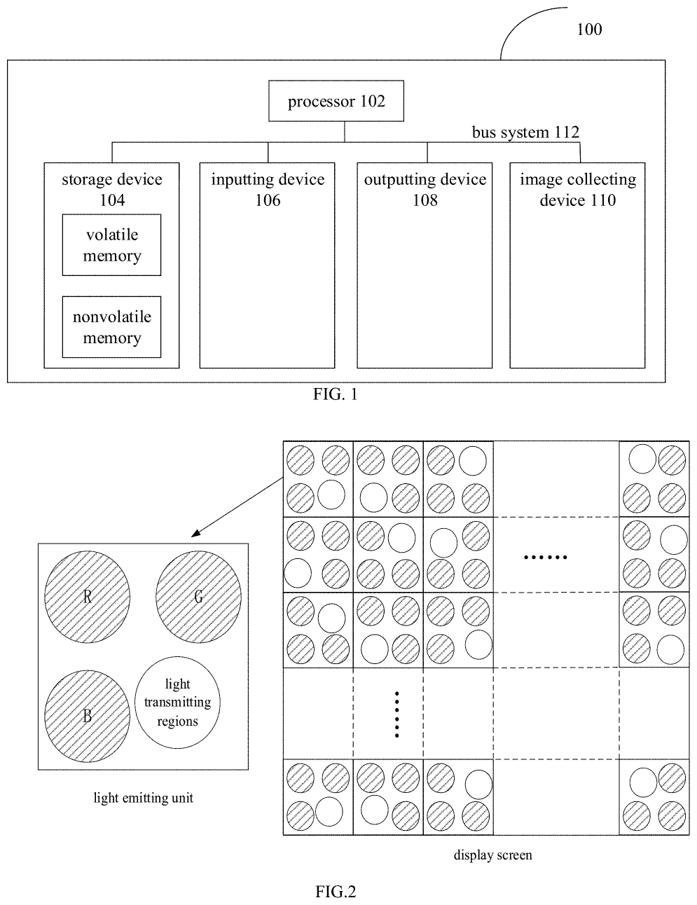

In a feasible structure, the electronic device may include a display screen. Referring to the schematic structural diagram of the display screen shown in FIG. 2, the display screen may include a plurality of light emitting units and a plurality of light transmitting regions. Each of the light emitting units includes sub-pixels of a preset quantity. Referring to the example of the enlarged light emitting unit on the left of FIG. 2, each of the light emitting units may include three sub-pixels of R (red color), G (green color) and B (blue color). Certainly, the light emitting unit may also be in another form; for example, it may also include four sub-pixels of R (red color), G (green color), B (blue color) and W (white color), which is not limited in the present embodiment.

In practical applications, the plurality of light emitting units may be arranged in a matrix, as a triangle or in another mode. Such modes of arrangement are the same as the modes of arrangement of the light emitting units in conventional display screens (i.e., display screens not provided with an under-screen camera), and therefore the display screen can be produced and manufactured by directly using the prior art, to prevent technical difficulties that might emerge. Furthermore, such modes of arrangement can enable the display screen according to the present embodiment to have an effect of displaying close to that of the display screens not having an under-screen camera, so as to bring the users a good visual experience. Certainly, the plurality of light emitting units may also be arranged in other regular or irregular modes, which is not limited in the embodiments of the present disclosure.

When an external target light source is transmitting the display screen, the light transmitting regions that are repeatedly arranged in conventional display screens easily cause the uneven diffraction fringes, which affects the effect of the image photographing. In view of that, the plurality of sub-pixels of the plurality of light emitting units have gaps therebetween, to form the plurality of light transmitting regions in the gaps, wherein the plurality of light transmitting regions include at least two non-repetitive first light transmitting regions.

It can be noted that, in some embodiments, a plurality of sub-pixels of the same light emitting unit may form the gap therebetween, or the sub-pixels of two light emitting units may form the gap therebetween. Among a plurality of sub-pixels in the same light emitting unit, there may be at least two sub-pixels that are connected, and do not have a gap therebetween. In the gap between two neighboring sub-pixels, there may be one or more light transmitting parts, and may also not be a light transmitting part. As an example, the plurality of sub-pixels of the plurality of light emitting units are separate, to form the gaps in the separated regions between the plurality of sub-pixels. One or more light transmitting parts are provided in the gaps between some of the sub-pixels of the plurality of sub-pixels of the plurality of first light emitting units. As an example, the plurality of sub-pixels of at least one of the light emitting units do not have gaps therebetween, and the edges are interconnected. Alternatively, the plurality of sub-pixels of different light emitting units are not separate, and the edges are interconnected.

For example, the display screen is delimited into a plurality of light emitting units and non-light emitting regions between the light emitting units, and the plurality of light transmitting regions are located at the non-light emitting regions, and include at least two non-repetitive first light transmitting regions. Particularly, that may include that a plurality of first light transmitting regions are non-repetitively distributed, or that a plurality of light transmitting regions are non-repetitively distributed and unevenly distributed relative to a plurality of pixel regions.

Regarding the mode of the non-repetitive distribution of the plurality of first light transmitting regions, they may be arranged in one or more of the following modes:

in the first mode, the at least two first light transmitting regions have different size parameters, appearance parameters, gesture parameters and position-distribution parameters;

in the second mode, each of the first light transmitting regions and another light transmitting region have different size parameters, appearance parameters, gesture parameters and position-distribution parameters; and

in the third mode, all of the light transmitting regions have different size parameters, appearance parameters, gesture parameters and position-distribution parameters.

The different size parameters refer to the difference in the sizes of the light transmitting regions. The different appearance parameters refer to the difference in the shapes of the light transmitting regions, such as a circle, a rectangle and a polygon. The different gesture parameters refer to that the light transmitting regions have different rotation angles. The different position-distribution parameters refer to that the light transmitting regions are not aligned, and have certain dislocation and deviation.

Those are not listed exhaustively here. Accordingly, it can be seen that the relative-position relation between one light transmitting region and another light transmitting region has no regularity, the relative-position relation between the light transmitting regions and the sub-pixels in the corresponding light emitting units has no regularity, and the relative-position relation between the same type of sub-pixels (for example, the R sub-pixels) has no regularity. In other words, the arrangement of the light transmitting regions is random, and is non-repetitive. The above-described arrangement relation between the light transmitting regions and the sub-pixels refer to that, at the visual level, all of the light transmitting regions and the sub-pixels are at the light emitting face of the display screen. Therefore, the light transmitting regions and the sub-pixels may be deemed as in the same two-dimensional plane, and the level structures forming the sub-pixels such as the cathode, the anode and the luminescent material are not limited.

Furthermore, it can be understood that, in order to ensure the effect of displaying of the display screen, the light transmitting regions and the sub-pixels should not overlap; in other words, each of the sub-pixels in the plurality of light emitting units is separate from each of the plurality of light transmitting regions.

In another embodiment, in order to prevent the uneven diffraction fringes when an external target light source is transmitting the display screen, the display screen is configured so that the plurality of sub-pixels of at least two of the light emitting units are non-repetitively distributed.

Regarding the mode of the non-repetitive distribution of the plurality of sub-pixels in the light emitting units, they may be arranged in one or more of the following modes:

in the first mode, a plurality of sub-pixels of at least two of the light emitting units have different size parameters, appearance parameters, gesture parameters and position-distribution parameters;

in the second mode, a plurality of sub-pixels of at least two of the light emitting units and a plurality of sub-pixels of another light emitting unit have different size parameters, appearance parameters, gesture parameters and position-distribution parameters; and

in the third mode, a plurality of sub-pixels of all of the light emitting units have different size parameters, appearance parameters, gesture parameters and position-distribution parameters.

The different size parameters refer to the difference in the sizes of the sub-pixels. The different appearance parameters refer to the difference in the shapes of the sub-pixels, such as a circle, a rectangle and a polygon. The different gesture parameters refer to that the sub-pixels have different rotation angles. The different position-distribution parameters refer to that the sub-pixels are not aligned, and have certain dislocation and deviation.

Optionally, the two above-described modes of preventing the uneven diffraction fringes may be combined, wherein at least two light transmitting regions that are non-repetitively distributed are formed in gaps between the plurality of sub-pixels that are non-repetitively distributed.

By forming the plurality of non-repetitive first light transmitting regions between the sub-pixels, or non-repetitively distributing the plurality of sub-pixels of at least two of the light emitting units, the luminances of the diffraction fringes formed by the external target light source via the light transmitting opening can be uniformly distributed. Based on that, the diffraction-fringe image that is generated by the target light source via the display screen can be an image of evenly distributed fringes, whereby the image photographed by the under-screen camera via the display screen is an obscure image of a uniform distribution. The regularity of the image of evenly distributed fringes can be accurately determined, whereby in the image processing, the difficulty of the image restoration can be reduced, and the obscure image can be restored by using a simple image processing method. It should be noted that the target light source may generally be selected to be a light source that easily generates diffraction, such as a pointolite and a linear light source.

Based on the display screen of the above structures, the electronic device according to the present embodiment may also be an electronic device having an under-screen camera. The display screen may be an OLED display screen, the region where the under-screen camera is located is a transparent OLED display screen, and when the region is not displaying a frame, it presents a transparent state, whereby the external environment light ray can transmit the transparent OLED display screen and reach the under-screen camera, thereby finally realizing the imaging. The position relation between the camera and the OLED display screen is equivalent to that the camera is hidden under the OLED display screen, and accordingly the camera may be referred to as an under-screen camera. Furthermore, components such as a circuit layer and a substrate layer may be provided between the OLED display screen and the under-screen camera.

In practical applications, the under-screen camera may be an internal camera of the electronic device; in other words, the electronic device, the display screen and the under-screen camera are of an integral structure. Furthermore, the under-screen camera may also be a camera independent of the electronic device, for example, an independent camera or a camera in another device; in other words, the under-screen camera and the electronic device having the display screen are of a combined structure.

Based on the electronic device according to the above-described embodiments, an embodiment of the present disclosure provides an image processing method that applies the electronic device. Referring to the flow chart of the image processing method shown in FIG. 3, the method particularly includes the following step S302 to step S306:

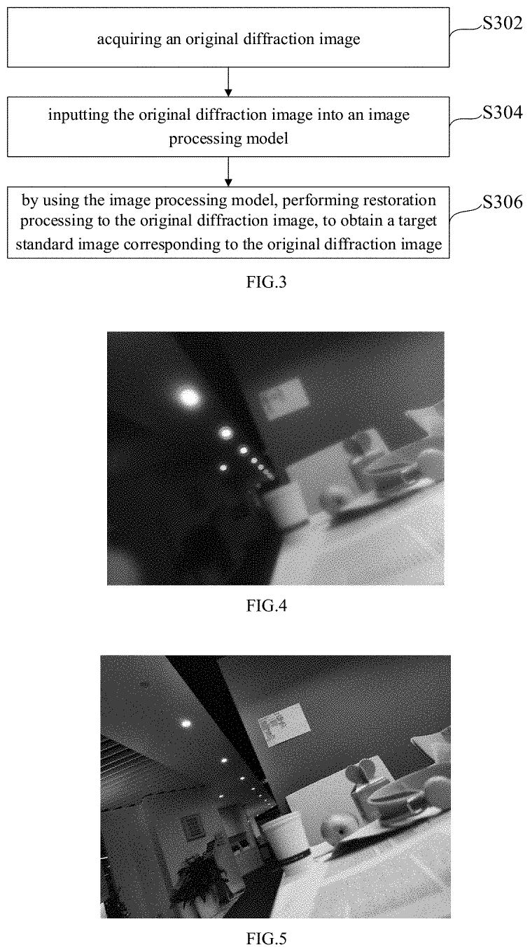

Step S302: acquiring an original diffraction image. The original diffraction image may refer to an image that is collected by the under-screen camera of the electronic device in an actual photographed scene. Because the under-screen camera is provided under the display screen, it may be deemed that the under-screen camera photographs the original diffraction image via the display screen. The photographed scene refers to any scene that contains light, for example a scene where a target light source exists. Taking a photographed scene where a target light source exists as an example, the schematic diagram of the original diffraction image shown in FIG. 4 may be provided, wherein in the original diffraction image the region of the target light source has obvious diffraction fringes, and the original diffraction image is obscure overall. Certainly, based on the physical significance of diffraction, it can be understood that, in a photographed scene where a target light source does not exist, diffraction fringes also emerge in the original diffraction image photographed by using the under-screen camera.

Step S304: inputting the original diffraction image into an image processing model. The image processing model is for example a neural network model such as LeNet, R-CNN (Region-CNN) or Resnet.

In practical applications, the image processing model is obtained by training in advance based on an image-sample pair. The image-sample pair includes a sample standard image and a sample diffraction image that correspond to the same scene. The sample standard image may be comprehended as an image that is obtained by photographing a specified scene by using an on-screen camera. The on-screen camera should not be simply comprehended as a camera provided over the display screen, and it is merely defined as “on screen” opposite to the under-screen camera. Generally, the on-screen camera may be a common photographing device in production applications, for example, a camera and a rear-facing camera of a mobile phone. Because the sample standard image is an image photographed by using the on-screen camera, the sample standard image may also be referred to as an on-screen image. The photographing by the on-screen camera is not adversely affected by the display screen, and, based on that, the sample standard image is a high-quality image having a good clarity.

The sample diffraction image is an image obtained by simulating the under-screen camera to photograph the specified scene based on the sample standard image, and/or is an image obtained by photographing the specified scene by using the under-screen camera. Because the sample diffraction image is an image photographed by the under-screen camera or by simulating the under-screen camera, the sample diffraction image may also be referred to as an under-screen image, and the sample diffraction image is generally an obscure image containing the diffraction fringes.

It should be noted that the under-screen camera in this step for photographing and obtaining the sample diffraction image and the under-screen camera in the step S302 for collecting the original diffraction image are not necessarily the same under-screen camera.

Step S306: by using the image processing model, performing restoration processing to the original diffraction image, to obtain a target standard image corresponding to the original diffraction image.

In a feasible implementation, the image processing model may be used to remove the diffraction fringes in the original diffraction image, and subsequently restore the image obtained after the diffraction fringes have been removed, to obtain the target standard image having a higher clarity. The obtained target standard image may refer to FIG. 5, and is a restored image corresponding to the original diffraction image, whose clarity has been obviously increased.

The above-described image processing method according to the embodiments of the present disclosure can restore the original diffraction image by directly using the image processing model, which effectively simplifies the mode of the image restoration and can increase the clarity of the target standard image that has been restored, thereby effectively improving the effect of the displaying of the image by the display screen.

In order to facilitate the comprehension, the mode of restoring the original diffraction image in the step S306 will be described in detail in the present embodiment. The image processing model may, based on a predetermined image restoration algorithm (such as Wiener filtering, regular filtering and blind-area convolution), perform restoration processing to the inputted original diffraction image, to obtain the target standard image.

As compared with an original diffraction image not containing a target light source, an original diffraction image containing a target light source has more obvious diffraction fringes. In order to better improve the effect of the restoration of the original diffraction image containing a target light source, the present embodiment may further provide another mode of restoring the original diffraction image, with reference to the following step (1) to step (3):

(1) by using the image processing model, detecting luminance values of pixel points in the original diffraction image.

(2) based on the detected luminance values, determining a light-spot region that contains a target light source in the original diffraction image. In a particular implementation, this step may include firstly according to positions of pixel points whose detected luminance values are greater than a preset luminance threshold, determining a luminance region in the original diffraction image; and subsequently determining whether a radius of a circumcircle of the luminance region is greater than a preset radius. If the radius of the circumcircle of the luminance region is greater than the preset radius (for instance, R>2 mm), that indicates that it is highly possible that the luminance region is a region containing the target light source, and therefore the luminance region is determined to be the light-spot region that contains the target light source. If the radius of the circumcircle of the luminance region is not greater than the preset radius, that indicates that the luminance region might be caused by a noise, an interfering light ray and so on, and therefore the luminance region is not determined to be the light-spot region.

(3) based on the light-spot region, performing the restoration processing to the original diffraction image, to obtain the target standard image corresponding to the original diffraction image.

In a feasible implementation, the restoration processing may be performed by using the following particular process. Firstly, the diffraction fringes are removed from the light-spot region, to obtain an image to be restored corresponding to the original diffraction image. In one original diffraction image there might be at least one light-spot region, and the diffraction fringes in each of the light-spot regions are removed, to obtain an image to be restored corresponding to the original diffraction image. Because, in the display screen, the light transmitting regions and the sub-pixels are non-repetitively arranged, the diffraction fringes are fringes whose luminances are evenly distributed, and, based on that, the difficulty in the removal of the diffraction fringes can be effectively reduced.

Subsequently, clarity processing is performed to the image to be restored, to obtain the target standard image. In practical applications, the clarity processing may be performed to the image to be restored by using various methods, such as a Lucy-Richardson image restoration method, Wiener filtering or constrained least square filtering, to obtain a target standard image of a good image quality and a high clarity.

In conclusion, the above-described image processing method according to the present embodiment can restore the original diffraction image by directly using the image processing model, which effectively simplifies the mode of the image restoration and can increase the clarity of the target standard image that has been restored, thereby effectively improving the effect of the displaying of the image by the display screen. Further, based on the applied electronic device, the display screen of the electronic device has the non-repetitive light transmitting regions. Therefore, the original diffraction image, which can be easily restoration-processed, can be acquired, and subsequently the original diffraction image is restored by using the image processing model, which cannot only increase the clarity of the image that has been restored and improve the effect of displaying of the display screen, but can also, based on the original diffraction image that can be easily restoration-processed, effectively improve the effect of the image restoration.

In order that the image processing model can be directly applied to the restoration of the original diffraction image, to output a clearer target standard image, it is required to train in advance the image processing model, to finally determine the parameters in the image processing model that can satisfy the requirements. By using the parameters obtained by training, the result of the restoration of the original diffraction image by the image processing model can reach the expected requirements on the image quality. The present embodiment provides a method for training an image processing model. Referring to the flow chart of the training of the image processing model shown in FIG. 6, the method may particularly include the following step S602 to step S610:

Step S602: acquiring an image-sample pair. The image-sample pair includes a sample standard image and a sample diffraction image corresponding to the sample standard image. In an embodiment, the image-sample pair includes a sample standard image of a specified scene photographed by using an on-screen camera and a sample diffraction image corresponding to the sample standard image, wherein the sample diffraction image is an image obtained by simulating the under-screen camera to photograph the specified scene based on the sample standard image, and/or is an image obtained by photographing the specified scene by using the under-screen camera. It can be understood that the specified scenes corresponding to the sample standard image and to the sample diffraction image are the same scene.

It should be noted that this step is the stage of preparation of the training of the image processing model, and the purpose of this step is to prepare the image-sample pair. If a usable image-sample pair is already available, then this step may be omitted, and the step S604 may be directly executed.

Step S604: inputting an image-sample pair into the image processing model.

Referring to the above-described embodiments, the image-sample pair includes a sample standard image and a sample diffraction image corresponding to the sample standard image; for example, the sample standard image and the sample diffraction image are an on-screen image and an under-screen image respectively that correspond to the same scene.

Step S606: by using the image processing model, performing restoration processing to the sample diffraction image, to obtain a restored image of the sample diffraction image.

Step S608: according to the restored image and the sample standard image, determining a loss-function value corresponding to the image processing model.

Particularly, this step may include calculating a similarity between the restored image and the sample standard image, and according to the similarity, determining the loss-function value corresponding to the image processing model. In a particular implementation, the similarity between the restored image and the sample standard image may be calculated by using various similarity algorithms, such as a cosine similarity algorithm, a histogram algorithm or a structural similarity measurement algorithm.

Step S610: according to the loss-function value, performing iterative updating to parameters of the image processing model.

Because, by performing the parameter updating one time, the image processing model cannot necessarily reach the expected effect, so it is required to perform iterative updating. Particularly, firstly, it is determined whether the loss-function value is converged to a preset value, and/or whether the iterative updating reaches a preset time quantity. On the condition that the loss-function value is converged to the preset value and/or the iterative updating reaches the preset time quantity, the training may be ended, and a trained image processing model is obtained.

For example, firstly it is determined whether the loss-function value is converged to a preset value. If it is converged to the preset value, the training may be ended, and an image processing model that is trained is obtained. If it is not converged to the preset value, then the iterative updating to the parameters of the image processing model is continued. Furthermore, an iteration time quantity may be set, and when the preset iteration time quantity is reached and the loss-function value is reduced to the preset value, the training is ended.

In addition, the state of the convergence of the loss-function value and the iteration time quantity may be comprehensively taken into consideration, wherein only when the loss-function value is converged to the preset value and the iterative updating reaches the preset time quantity, the training can be ended.

In the above-described training mode according to the present embodiment, by using the sample standard image and the sample diffraction image having the correspondence relation as the training data, the difference between the two images in the image-sample pair can be reduced, or, in other words, the quality of the image-sample pair is increased. The image-sample pair of the higher quality facilitates to improve the effect of the training of the image processing model. Moreover, by using the similarity as the loss-function value, the difficulty in the calculation of the loss function is reduced, which can increase the efficiency of the training of the image processing model.

In the above-described process of the training of the image processing model, a large quantity of high-quality and diversified image-sample pairs are required and relied on as the training data. In view of that, the present embodiment provides two modes of acquiring the image-sample pair below.

The first acquiring mode: by using an on-screen camera, at a preset photographing angle, photographing a specified scene, to obtain a sample standard image; and by using an under-screen camera, at the photographing angle, photographing the specified scene, to obtain the sample diffraction image.

In such a mode of acquiring the image-sample pair, all of the photographing angles and the photographed specified scenes of the on-screen camera and the under-screen camera are the same, and therefore the obtained sample standard image and sample diffraction image are substantially the same, and can be used as the training data of the image processing model. Such an acquiring mode is simple and easily operable, and has a low requirement on the working capacity of the user.

The second acquiring mode: the sample standard image and the sample diffraction image might have deviations in the image contents, the photographing angles and so on, which adversely affects the effect of the training of the image processing model, and, in practical applications, results in a poor quality of the image that is restored. In order to prevent the above problems, in the present embodiment, a sample standard image and a sample diffraction image that have a good matching degree may be acquired in the following mode, including:

firstly, by using an on-screen camera, photographing a specified scene, to obtain the sample standard image; subsequently, by using the on-screen camera, via a displaying screen, photographing a target light source in a dark background, to obtain a target-light-source image, wherein in order to increase the simulation fidelity between the sample diffraction image and the real under-screen image photographed by the under-screen camera, the displaying screen is the same as the display screen of the electronic device; and, finally, performing convolution operation to the target-light-source image and the sample standard image, to obtain the sample diffraction image.

In the above-described mode, by generating based on the sample standard image a sample diffraction image simulating the under-screen image, the deviations between the sample standard image and the sample diffraction image can be prevented, and therefore the image processing model that is obtained by training based on the image-sample pair can have a better effect of restoration, which improves the clarity and the image quality of the restored image.

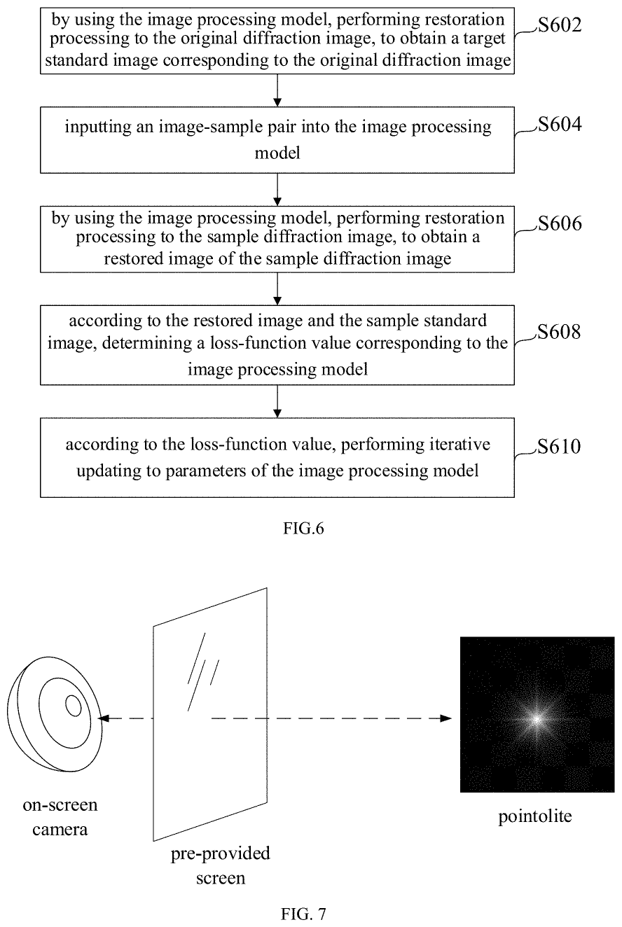

In order to better comprehend the candidate target-light-source image, a mode of acquiring the candidate target-light-source image is provided here. Referring to the schematic diagram of the photographed scene of the target-light-source image shown in FIG. 7, an on-screen camera, a displaying screen and a target light source that are sequentially arranged are exhibited, wherein the on-screen camera and the displaying screen are equivalent to simulating the photographing mode of the under-screen camera via the display screen. Based on the scene shown in FIG. 7, the mode of acquiring the candidate target-light-source image includes: by using the on-screen camera, via the displaying screen, photographing the target light source in a predetermined theme, to obtain a candidate target-light-source image, wherein the predetermined theme refers to a theme for performing spatial arrangement to at least one target light source in a dark background, and in different instances of the predetermined theme, a quantity of the target light sources and/or a mode of the spatial arrangement of the target light sources are different. For example, the first predetermined theme is one target light source in a dark background, wherein the spatial arrangement mode of the target light source is having a specified distance from the displaying screen. The second predetermined theme is three target light sources in a dark background, wherein the spatial arrangement mode of the three target light sources is being arranged into one column, one row or one triangle at certain distances. The third predetermined theme is n (wherein n is an arbitrary value greater than 1) target light sources in a dark background, wherein the n target light sources may have multiple spatial arrangement modes, for example arrangement into multiple columns, random distribution and so on. Multiple predetermined themes may be provided according to the actual life scenes (such as an office working scene, a family-life scene and an outdoor scene), to acquire the candidate target-light-source image corresponding to each of the predetermined themes, thereby improving the diversity of the candidate target-light-source image.

The mode further includes determining at least one of the candidate target-light-source images to be the target-light-source image. As the candidate target-light-source images are diversified, the different candidate target-light-source images and the sample standard images in the different specified scenes have multiple modes of combination therebetween, and a large quantity of image-sample pairs can be conveniently and quickly obtained, which increases the quantity and the diversity of the image-sample pairs. Based on the enriched image-sample pairs, the effect of the image restoration by the image processing model can be improved. In another embodiment, multiple candidate target-light-source images may be determined to be the target-light-source image.

In practical applications, the target-light-source image may also undergo denoising processing, and convolution operation may be performed by using the target-light-source image obtained after the denoising processing and the sample standard image, thereby obtaining a sample diffraction image having a better quality.

Based on the above description, the image-sample pairs acquired according to the present embodiment have the characteristics of a high quality and a good diversity, which facilitates to better train the image processing model, thereby improving the effect of the image restoration by the image processing model in practical applications, and effectively improving the clarity and the frame quality of the image that has been restored.

### The Third Embodiment

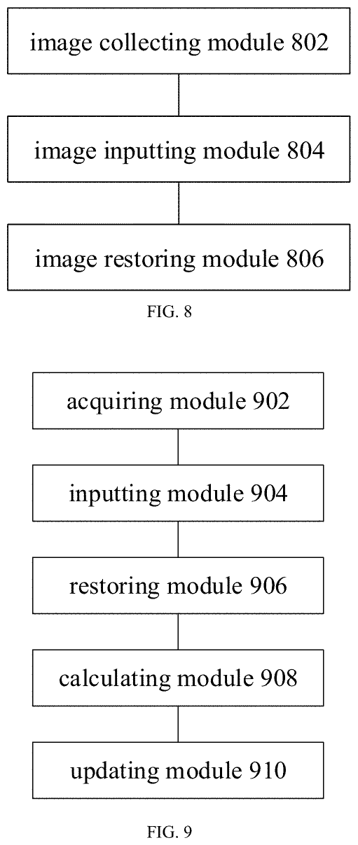

Based on the image processing method according to the above-described embodiments, the present embodiment provides an image processing apparatus. Referring to the structural block diagram of the image processing apparatus shown in FIG. 8, the apparatus is applied to an electronic device having an under-screen camera, and the apparatus includes:

an image collecting module 802 configured for acquiring an original diffraction image;

an image inputting module 804 configured for inputting the original diffraction image into an image processing model; and

an image restoring module 806 configured for, by using the image processing model, performing restoration processing to the original diffraction image, to obtain a target standard image corresponding to the original diffraction image.

The above-described image processing apparatus according to the embodiments of the present disclosure can restore the original diffraction image by directly using the image processing model, which effectively simplifies the mode of the image restoration and can increase the clarity of the target standard image that has been restored, thereby effectively improving the effect of the displaying of the image by the display screen.

In some embodiments, the image restoring module 806 is further configured for:

by using the image processing model, detecting luminance values of pixel points in the original diffraction image;

based on the detected luminance values, determining a light-spot region that contains a target light source in the original diffraction image; and

based on the light-spot region, performing the restoration processing to the original diffraction image, to obtain the target standard image corresponding to the original diffraction image.

In some embodiments, the image restoring module 806 is further configured for:

removing diffraction fringes from the light-spot region, to obtain an image to be restored corresponding to the original diffraction image; and

performing clarity processing to the image to be restored, to obtain the target standard image.

In some embodiments, the image restoring module 806 is further configured for:

according to positions of pixel points whose detected luminance values are greater than a preset luminance threshold, determining a luminance region in the original diffraction image;

determining whether a radius of a circumcircle of the luminance region is greater than a preset radius; and

if yes, determining the luminance region to be the light-spot region that contains the target light source.

In some embodiments, the image collecting module 802 is further configured for:

by using an under-screen camera provided at the electronic device, collecting the original diffraction image.

In some embodiments, the image processing model is obtained by training based on an image-sample pair, wherein the image-sample pair includes a sample standard image of a specified scene photographed by using an on-screen camera and a sample diffraction image corresponding to the sample standard image, wherein the sample diffraction image is an image obtained by simulating the under-screen camera to photograph the specified scene based on the sample standard image, and/or is an image obtained by photographing the specified scene by using the under-screen camera.

In some embodiments, the electronic device includes a display screen, and the display screen includes a plurality of light emitting units and a plurality of light transmitting regions, wherein each of the light emitting units includes sub-pixels of a preset quantity; and the plurality of light transmitting regions are non-repetitively arranged between the sub-pixels of the plurality of light emitting units, whereby the diffraction-fringe image that is generated by the target light source via the display screen is an image of evenly distributed fringes.

In some embodiments, each of the sub-pixels in the plurality of light emitting units is separate from each of the plurality of light transmitting regions.

In some embodiments, the electronic device is an electronic device having an under-screen camera.

The principle of the implementation and the obtained technical effects of the apparatus according to the present embodiment are the same as those of the image processing method according to the second embodiment. In order to simplify the description, the contents that are not mentioned in the present embodiment may refer to the corresponding contents in the second embodiment.

### The Fourth Embodiment

Based on the method for training an image processing model according to the above-described embodiments, the present embodiment provides an apparatus for training an image processing model. Referring to the structural block diagram of the apparatus for training an image processing model shown in FIG. 9, the apparatus includes:

an inputting module 904 configured for inputting an image-sample pair into the image processing model, wherein the image-sample pair includes a sample standard image and a sample diffraction image corresponding to the sample standard image;

a restoring module 906 configured for, by using the image processing model, performing restoration processing to the sample diffraction image, to obtain a restored image of the sample diffraction image;

a calculating module 908 configured for, according to the restored image and the sample standard image, determining a loss-function value corresponding to the image processing model; and

an updating module 910 configured for, according to the loss-function value, performing iterative updating to parameters of the image processing model.

In the apparatus for training an image processing model according to the present embodiment, by using the sample standard image and the sample diffraction image having the correspondence relation as the training data, the difference between the two images in the image-sample pair can be reduced, or, in other words, the quality of the image-sample pair is increased. The image-sample pair of the higher quality facilitates to improve the effect of the training of the image processing model. Moreover, by using the similarity as the loss-function value, the difficulty in the calculation of the loss function is reduced, which can increase the efficiency of the training of the image processing model.

In some embodiments, the training apparatus may further include an acquiring module 902 configured for: by using an on-screen camera, photographing a specified scene, to obtain the sample standard image; determining at least one of the candidate target-light-source images to be the target-light-source image, wherein the candidate target-light-source image is an image that is obtained by, by using the on-screen camera, via the displaying screen, photographing a target light source in a dark background; and performing convolution operation to the target-light-source image and the sample standard image, to obtain the sample diffraction image.

In some embodiments, the training-data acquiring module 902 is further configured for: by using the on-screen camera, via the displaying screen, photographing the target light source in a predetermined theme, to obtain a plurality of candidate target-light-source images, wherein the predetermined theme refers to a theme for performing spatial arrangement to at least one target light source in a dark background, in different instances of the predetermined theme a quantity of the target light sources and/or a mode of the spatial arrangement of the target light sources are different, and candidate target-light-source images corresponding to different instances of the predetermined theme are different.

In some embodiments, the training-data acquiring module 902 is further configured for:

performing denoising processing to the target-light-source image or the candidate target-light-source image.

In some embodiments, the displaying screen is a displaying screen the same as the display screen of the electronic device in the image processing method according to the second embodiment.

In some embodiments, the training-data acquiring module 902 is further configured for:

by using an on-screen camera, at a preset photographing angle, photographing a specified scene, to obtain a sample standard image; and

by using an under-screen camera, at the photographing angle, photographing the specified scene, to obtain the sample diffraction image.

The principle of the implementation and the obtained technical effects of the apparatus according to the present embodiment are the same as those of the method for training an image processing model according to the second embodiment. In order to simplify the description, the contents that are not mentioned in the present embodiment may refer to the corresponding contents in the second embodiment.

### The Fifth Embodiment

On the basis of the above-described embodiments, the present embodiment provides an image processing system, wherein the system includes a processor and a storage device; and

the storage device stores a computer program, and the computer program, when executed by the processor, implements the image processing method of any one of the items according to the second embodiment, or implements the method for training an image processing model of any one of the items according to the second embodiment.

A person skilled in the art can clearly understand that, in order for the convenience and concision of the description, the particular working processes of the above-described systems may refer to the corresponding processes according to the above-described process embodiments, and are not discussed here further.

### The Sixth Embodiment

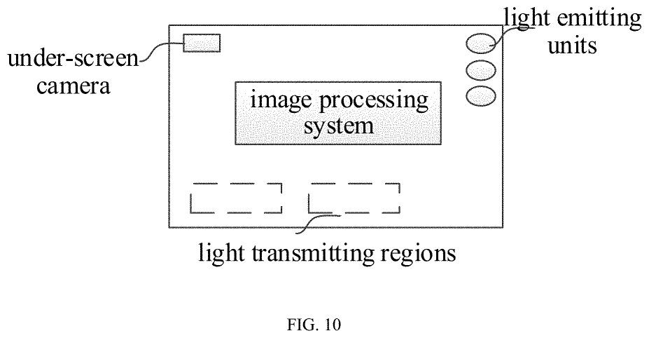

Referring to FIG. 10, on the basis of the above-described embodiments, the present embodiment provides an electronic device, wherein the electronic device includes a display screen and an under-screen camera, and further includes the image processing system according to the above embodiment; and

the display screen includes a plurality of light emitting units and a plurality of light transmitting regions, wherein each of the light emitting units includes a plurality of sub-pixels.

Optionally, the plurality of sub-pixels of the plurality of light emitting units have gaps therebetween, to form the plurality of light transmitting regions in the gaps, wherein the plurality of light transmitting regions include at least two non-repetitive first light transmitting regions.

Optionally, the plurality of sub-pixels of at least two of the light emitting units are non-repetitively distributed.

A person skilled in the art can clearly understand that, in order for the convenience and concision of the description, the particular working processes of the above-described systems may refer to the corresponding processes according to the above-described process embodiments, and are not discussed here further.

Optionally, the present embodiment further provides a computer-readable storage medium, the computer-readable storage medium storing a computer program, wherein the computer program, when executed by a processing device, implements the steps of the image processing method of any one of the items according to the second embodiment, or implements the steps of the method for training an image processing model of any one of the items according to the second embodiment.

The computer program product for the image processing method and apparatus, and the method and apparatus for training an image processing model according to the embodiments of the present disclosure includes a computer-readable storage medium storing a program code, and an instruction contained in the program code may be configured to implement the image processing method or the method for training an image processing model according to the above-described process embodiments, the particular implementations of which may refer to the process embodiments, and are not discussed here further.

The functions that are required by the image processing method or the method for training an image processing model, if implemented in the form of software function units and sold or used as an independent product, may be stored in a computer-readable storage medium. On the basis of such a comprehension, the substance of the technical solutions according to the present disclosure, or the part thereof that makes a contribution over the prior art, or part of the technical solutions, may be embodied in the form of a software product. The computer software product is stored in a storage medium, and contains multiple instructions configured so that a computer device (which may be a personal computer, a server, a network device and so on) implements all or some of the steps of the methods according to the embodiments of the present disclosure. Moreover, the above-described storage medium includes various media that can store a program code, such as a USB flash disk, a mobile hard disk drive, a read-only memory (ROM), a random access memory (RAM), a diskette and an optical disc.

An embodiment of the present application further provides a computer program, wherein the computer program includes a computer-readable code, and when the computer-readable code is executed in a computing and processing device, the computer-readable code causes the computing and processing device to implement the image processing method stated above or the method for training an image processing model stated above.

Finally, it should be noted that the embodiments described above are merely particular embodiments of the present disclosure, and are intended to explain the technical solutions of the present disclosure, and not to limit them, and the protection scope of the present disclosure is not limited thereto. Although the present disclosure is explained in detail with reference to the above embodiments, a person skilled in the art should understand that a person skilled in the art can, within the technical scope disclosed by the present disclosure, easily envisage modifications or variations on the technical solutions set forth in the above embodiments, or make equivalent substitutions to some of the technical features thereof, and those modifications, variations or substitutions do not make the essence of the corresponding technical solutions depart from the spirit and scope of the technical solutions of the embodiments of the present disclosure, and should all be encompassed by the protection scope of the present disclosure. Therefore, the protection scope of the present disclosure should be subject to the protection scope of the appended claims.

1. An image processing method, wherein the method is applied to an electronic device, and the method comprises:
acquiring an original diffraction image;
inputting the original diffraction image into an image processing model; and
by using the image processing model, performing restoration processing to the original diffraction image, to obtain a target standard image corresponding to the original diffraction image.

2. The method according to claim 1, wherein the step of, by using the image processing model, performing the restoration processing to the original diffraction image, to obtain the target standard image corresponding to the original diffraction image comprises:
by using the image processing model, detecting luminance values of pixel points in the original diffraction image;
based on the detected luminance values, determining a light-spot region that contains a target light source in the original diffraction image; and
based on the light-spot region, performing the restoration processing to the original diffraction image, to obtain the target standard image corresponding to the original diffraction image.

3. The method according to claim 2, wherein the step of, based on the light-spot region, performing the restoration processing to the original diffraction image comprises:
removing diffraction fringes from the light-spot region, to obtain an image to be restored corresponding to the original diffraction image; and
performing clarity processing to the image to be restored, to obtain the target standard image.

4. The method according to claim 2, wherein the step of, based on the detected luminance values, determining the light-spot region that contains the target light source in the original diffraction image comprises:
according to positions of pixel points whose detected luminance values are greater than a preset luminance threshold, determining a luminance region in the original diffraction image;
determining whether a radius of a circumcircle of the luminance region is greater than a preset radius; and
if yes, determining the luminance region to be the light-spot region that contains the target light source.

5. The method according to claim 1, wherein the step of acquiring the original diffraction image comprises:
by using an under-screen camera provided at the electronic device, collecting the original diffraction image.

6. The method according to claim 1, wherein the image processing model is obtained by training based on an image-sample pair, wherein the image-sample pair comprises a sample standard image of a specified scene photographed by using an on-screen camera and a sample diffraction image corresponding to the sample standard image, wherein the sample diffraction image is an image obtained by simulating the under-screen camera to photograph the specified scene based on the sample standard image, and/or is an image obtained by photographing the specified scene by using the under-screen camera.

7. The method according to claim 1, wherein the electronic device comprises a display screen, and the display screen comprises a plurality of light emitting units and a plurality of light transmitting regions, wherein each of the light emitting units comprises sub-pixels of a preset quantity; and the plurality of sub-pixels of the plurality of light emitting units have gaps therebetween, to form the plurality of light transmitting regions in the gaps, wherein the plurality of light transmitting regions include at least two non-repetitive first light transmitting regions.

8. The method according to claim 7, wherein each of the sub-pixels in the plurality of light emitting units is separate from each of the plurality of light transmitting regions.

9. The method according to claim 7, wherein the at least two non-repetitive first light transmitting regions are one or more of the following first light transmitting regions:
the at least two first light transmitting regions have different size parameters, appearance parameters, gesture parameters and position-distribution parameters;
each of the first light transmitting regions and another light transmitting region have different size parameters, appearance parameters, gesture parameters and position-distribution parameters; and
all of the light transmitting regions have different size parameters, appearance parameters, gesture parameters and position-distribution parameters.

10. The method according to claim 1, wherein the electronic device comprises a display screen, and the display screen comprises a plurality of light emitting units and a plurality of light transmitting regions, wherein each of the light emitting units comprises sub-pixels of a preset quantity; and the plurality of sub-pixels of at least two of the light emitting units are non-repetitively distributed.

11. The method according to claim 10, wherein at least two light transmitting regions that are non-repetitively distributed are formed in gaps between the plurality of sub-pixels that are non-repetitively distributed.

12. The method according to claim 10, wherein the light emitting units are one or more of the following light emitting units:
the plurality of sub-pixels of at least two of the light emitting units have different size parameters, appearance parameters, gesture parameters and position-distribution parameters;
the plurality of sub-pixels of at least two of the light emitting units and a plurality of sub-pixels of another light emitting unit have different size parameters, appearance parameters, gesture parameters and position-distribution parameters; and
a plurality of sub-pixels of all of the light emitting units have different size parameters, appearance parameters, gesture parameters and position-distribution parameters.

13. The method according to claim 7, wherein the electronic device is an electronic device having an under-screen camera.

14. A method for training an image processing model, wherein the method comprises:
inputting an image-sample pair into the image processing model, wherein the image-sample pair comprises a sample standard image and a sample diffraction image corresponding to the sample standard image;
by using the image processing model, performing restoration processing to the sample diffraction image, to obtain a restored image of the sample diffraction image;
according to the restored image and the sample standard image, determining a loss-function value corresponding to the image processing model; and
according to the loss-function value, performing iterative updating to parameters of the image processing model.

15-16. (canceled)

17. The method according to claim 14, wherein the image-sample pair is acquired by:
by using an on-screen camera, photographing a specified scene, to obtain the sample standard image;
by using the on-screen camera, via a displaying screen, photographing a target light source in a dark background, to obtain a target-light-source image; and
performing convolution operation to the target-light-source image and the sample standard image, to obtain the sample diffraction image.

18. The method according to claim 17, wherein the step of, by using the on- screen camera, via the displaying screen, photographing the target light source in the dark background, to obtain the target-light-source image comprises:
by using the on-screen camera, via the displaying screen, photographing the target light source in a predetermined theme, to obtain a candidate target-light-source image, wherein the predetermined theme refers to a theme for performing spatial arrangement to at least one target light source in a dark background, in different instances of the predetermined theme, a quantity of the target light sources and/or a mode of the spatial arrangement of the target light sources are different, and candidate target-light-source images corresponding to different instances of the predetermined theme are different; and
determining at least one of the candidate target-light-source images to be the target-light-source image.

19-20. (canceled)

21. The method according to claim 14, wherein the image-sample pair is acquired by:
by using an on-screen camera, at a preset photographing angle, photographing a specified scene, to obtain a sample standard image; and
by using an under-screen camera, at the photographing angle, photographing the specified scene, to obtain the sample diffraction image.

22-23. (canceled)

24. An image processing system, wherein the system comprises a processor and a storage device; and
the storage device stores a computer program, and the computer program, when executed by the processor, implements the image processing method according to claim 1.

25. An electronic device, wherein the electronic device comprises a display screen and an under-screen camera, and further comprises the image processing system according to claim 24; and
the display screen comprises a plurality of light emitting units and a plurality of light transmitting regions, wherein each of the light emitting units comprises a plurality of sub-pixels.

26-27. (canceled)

28. A computer-readable storage medium, the computer-readable storage medium storing a computer program, wherein the computer program, when executed by a processor, implements the steps of the image processing method according to claim 1.

29. (canceled)
